(19) United States
(12) Patent Application Publication
(10) Pub. No.: US 2010/0293007 A1
(43) Pub. Date: Nov. 18, 2010

(54) Provider Decision Support

(76) Inventor: Roy Schoenberg, Boston, MA (US)

Correspondence Address: FISH & RICHARDSON PC, P.O. BOX 1022, MINNEAPOLIS, MN, 55440-1022, US

(21) Appl. No.: 12/782,193

(22) Filed: May 18, 2010

Related U.S. Application Data
(60) Provisional application No. 61/179,333, filed on May 18, 2009.

(51) Int. Cl. G06Q 50/00; G06Q 10/00

(52) U.S. Cl. 705/3; 705/2

(57) ABSTRACT

A computer-implemented method is described for retrieving, from a data repository that stores decision support information, decision support information pertinent to a consumer of services with whom a service provider is engaged in a real-time consultation; and generating by one or more computers based on the retrieved decision support information one or more decision support items to facilitate decisions of the service provider in rendering medical care to the consumer of services.

### CLAIM OF PRIORITY

This application claims priority under 35 U.S.C. §119(e) to provisional U.S. Patent Application 61/179,333, filed on May 18, 2009, the entire contents of which are hereby incorporated by reference.

### BACKGROUND

The present invention is directed to connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in U.S. Pat. No. 7,590,550, which is incorporated herein by reference.

### SUMMARY

In one aspect of the present disclosure, a computer-implemented method comprises: retrieving, from a data repository that stores decision support information, decision support information pertinent to a consumer of services with whom a service provider is engaged in a real-time consultation; and generating by one or more computers based on the retrieved decision support information one or more decision support items to facilitate decisions of the service provider in rendering medical care to the consumer of services.

Implementations of the disclosure may include one or more of the following features. In some implementations, the decision support items comprise one or more visual representations of data to facilitate decisions of the service provider in rendering medical care to the consumer of services and include one or more of a first item that identifies omissions in health care coverage of the consumer of services, a second item that identifies medication alerts for medications that were prescribed to the consumer of services, and a third item that identifies a list of generic substitutions for the consumer's present medications. In other implementations, the data repository is a first data repository and the method further comprises: retrieving from a second data repository health information pertinent to the consumer of services; and causing the one or more computers to apply one or more decision support rules to the retrieved health information to generate the decision support information.

In still other implementations, the method further comprises: sending by the one or more computers to the service provider a message, the message including the one or more decision support items. The method also comprises generating a graphical user interface that when rendered on a display device displays a visual representation of the one or more decision support items and sending to the data repository that stores decision support information data indicative of one or more decision support items addressed with the consumer during the consultation.

In some implementations, the data repository is a first data repository and the method further comprises: retrieving from a second data repository health information pertinent to the consumer of services; and causing the one or more computers to send to the first data repository the retrieved health information pertinent to the consumer of services.

In another aspect of the disclosure, a computer program product is embodied on a computer readable storage medium, the computer program product comprising instructions for causing a computer to: retrieve, from a data repository that stores decision support information, decision support information pertinent to a consumer of services with whom a service provider is engaged in a real-time consultation; and generate based on the retrieved decision support information one or more decision support items to facilitate decisions of the service provider in rendering medical care to the consumer of services. Implementations of this aspect of the present disclosure can include one or more of the foregoing features.

In yet another aspect of the disclosure, an apparatus comprises a processor; and a computer program product embodied on a computer readable storage medium, the computer program product comprising instructions for causing the processor to: retrieve, from a data repository that stores decision support information, decision support information pertinent to a consumer of services with whom a service provider is engaged in a real-time consultation; and generate based on the retrieved decision support information one or more decision support items to facilitate decisions of the service provider in rendering medical care to the consumer of services. Implementations of this aspect of the present disclosure can include one or more of the foregoing features.

### BRIEF DESCRIPTION OF THE FIGURES

FIG. 1 is a block diagram of a computer-based brokerage system.

FIGS. 2-4 are flow charts of processes executed by the brokerage system.

FIGS. 5-8 are screen images of graphical user interfaces generated by the brokerage system.

### DETAILED DESCRIPTION

Through a brokerage system, a consumer of services engages in a consultation with a service provider, as described in my issued patent, U.S. Pat. No. 7,590,550. Additionally, through the brokerage system, a service provider accesses and views information of other service providers associated with the brokerage system.

As will be discussed herein, decision support information (e.g., real-time, evidence-based information and/or treatment recommendations for consumers) provide real-time guidance to a service provider regarding a consumer's treatment regimen by including recommendations to the service provider about topics that should be discussed or reviewed with the consumer. Recommendations include best practice guidelines, links to clinical references, and evidence-based medicine information generated by decision support information content providers (e.g., an application internal and/or external to the brokerage system, third-party vendors, pharmacy benefit managers, care/disease management systems, evidence-based medicine systems, internal and external clinical analytics systems).

Through the brokerage system, decision support information is imported from the content providers and/or generated by the brokerage system. The brokerage system generates a graphical user interface that when rendered on a display device renders a visual representation of the decision support information for the service provider (e.g., at the beginning and/or during a consultation with the consumer).

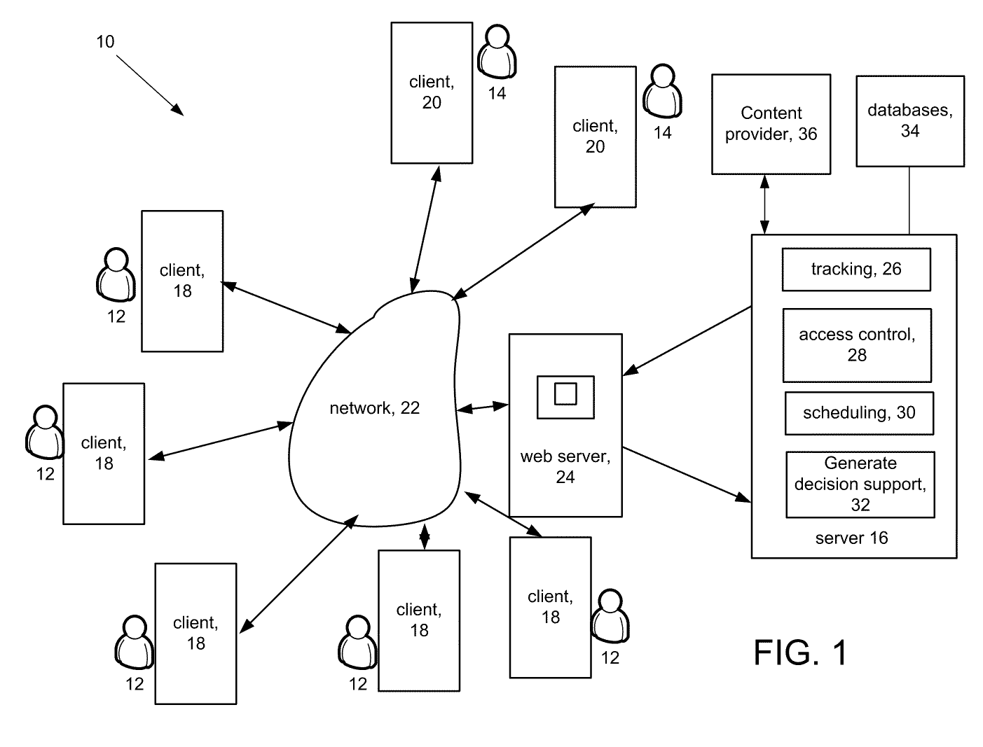

Referring to FIG. 1, a brokerage system 10 to provide a brokerage service to connect consumers of services 12 with providers of services 14 is shown. The system 10 includes a computerized system or server 16 for making connections between consumers 12, at client systems 18, and service providers 14, at client systems 20, over a network 22, e.g., the Internet or other types of networks. The computerized system 16 operates as a service running on, e.g., a web server 24.

The computerized system 16 includes an availability or presence tracking module 26 that tracks the availability of the service providers 14. The computerized system 16 includes an access control facility 28, which manages and controls whether a given consumer 12 has access to the system 16 and what level or scope of access to the features, functions, and services is provided by the system 16. The computerized system 16 also includes one or more processes such as a scheduling module 30. Also included in the computerized system 16 is a decision support module 32 that imports and integrates decision support information with the processes of the brokerage system 10, as described in more detail below. The system 16 accesses one or more content provider systems 36 to load decision support information into the system 16. The content provider systems 36 are part of and internal to the brokerage system 10. Alternatively, the content provider systems 36 are external to the brokerage system 10. The system 16 accesses one or more databases 34. The components of the system 16 and the web server 24 are integrated and/or distributed in various arrangements.

Using the system 10, a consumer 12 communicates with a provider 14. The consumers 12 and providers 14 connect to the computerized system 16 through a website or other interface on the web server 24 using client devices 18 and 20, respectively. Client devices 18 and 20 include any combination of, e.g., personal digital assistants, land-line telephones, cell phones, computer systems, media-player-type devices, and so forth. The client devices 18 and 20 enable the consumers 12 to input and receive information as well as to communicate via video, audio, and/or text with the providers 14.

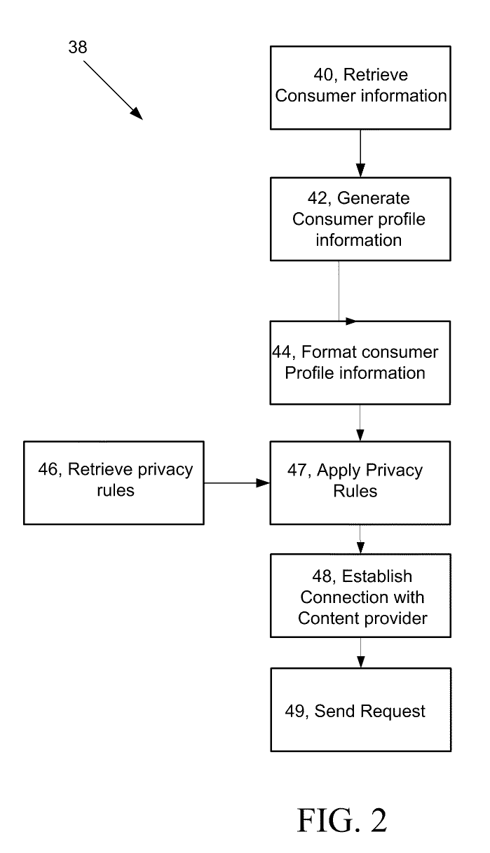

Referring to FIG. 2, the brokerage system 10 transmits 38 consumer information (e.g., consumer and conversation summary information, consumer identity information, health care provider identity information, health summary information, diagnoses, medications, allergies, immunizations and procedures information) to a content provider as follows. The brokerage system 10 retrieves 40 consumer information from database 34. The brokerage system 10 generates 42 consumer profile information based on the retrieved consumer information. The consumer profile information includes a comprehensive consumer profile of the received consumer information. The brokerage system 10 formats 44 the consumer profile information based on the data format specification (e.g., the Extensible Markup Language (“XML”) format) of the content provider receiving the consumer profile information. The brokerage system 10 retrieves 46 privacy rules from the database 34. The privacy rules are configured by a consumer and specify which content providers are authorized to receive the consumer's profile information based on attributes of the consumer (e.g., consumer profile information associated with a particular medical issue, disease or treatment of the consumer), the service provider (e.g., consumer profile information associated with a particular physician) and/or the consultation (e.g., time and date attributes). In one particular example, a consumer's privacy rules specify that consumer profile information pertaining to a particular dermalogical condition is to be shared with or sent to content providers. The brokerage system 10 applies 47 the privacy rules to the consumer profile information to determine the types of consumer profile information the consumer has authorized to be sent to the content providers.

The brokerage system establishes 48 a connection with the content providers receiving the consumer profile information. Encrypted data channels are established between the content providers and the brokerage system 10 for the transfer of the consumer profile information. The brokerage system authenticates servers 36 associated with the content providers through digital certificates and/or HTTPS authentication. The brokerage system uses a content provider definition file to establish a connection with the content provider. The content provider definition file is a file (e.g., an XML file) including data pertaining to the characteristics of the particular content provider. These content provider characteristics include: the unique name of the content provider, the title of the content provider, a Uniform Resource Identifier (“URI”) for connectivity to a service (e.g., a Simple Object Access Protocol (“SOAP”) web service) hosted by the content provider, the username and password for web service authentication with the content provider, and parameters specifying a format for a request for decision support information.

The brokerage system 10 sends 49 the content provider a request message (e.g., a SOAP-based Web service call) including a request for decision support information and the formatted consumer profile information to be used in generating the decision support information.

The brokerage system 10 sends 49 the request message when the brokerage system 10 receives updated or new consumer information. During a real-time consultation with a consumer, the service provider receives new consumer information (e.g., during a live, real-time consultation, the consumer informs the service provider that the consumer has had a headache for the last week). As the brokerage system 10 stores this new information in the database 34, the brokerage system 10 also sends a request message to the content provider requesting that the content provider send the brokerage system 10 any additional decision support information generated based on the new information. The decision support information is generated and retrieved in real-time by the content provider based on the real-time information received from the brokerage system 10.

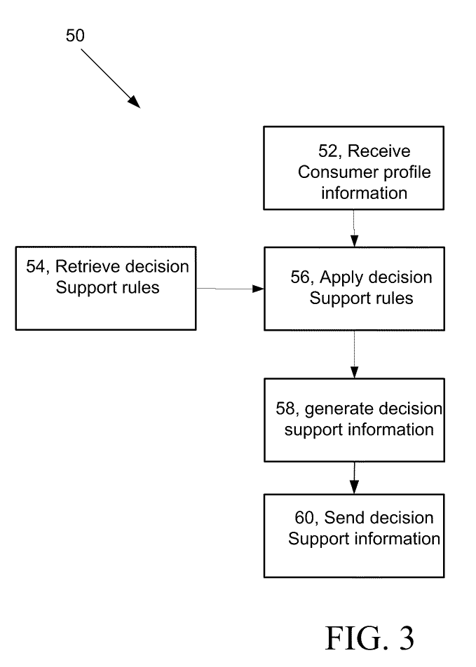

Referring to FIG. 3, the content provider generates 50 a message including decision support information as follows. The content provider receives 52 the consumer profile information and retrieves 54 decision support rules. The decision support rules specify various decision support information (e.g., recommendations) for when a consumer's profile information includes particular criteria (e.g., age, gender, criteria based on International Classification of Diseases (“ICD”) codes and criteria based on Current Procedural Terminology (“CPT”) codes).

Table 1, below, includes an example of a decision support rule to detect whether a consumer is at risk for osteoporosis. The rules specify that when various criteria (e.g., gender, age, ICD codes and CPT codes) are present in a consumer's profile that the consumer is at risk of osteoporosis and the rule specifies a recommendation of “follow-up with service provider regarding osteoporosis screening.” The decision support rules also include a hypertext link with the uniform resource location (“URL”) of guidelines supporting the recommendation, citation information (e.g., an administrative body developing the guidelines), and evidence information (e.g., information supporting the recommendation).

| | |
|---|---|
| Criteria | (Gender = Female) |
| | AND (Age >= 65) |
| | AND (Member's active diagnoses do not include any |
| | of the following ICD codes: |
| | 733.0 Osteoporosis |
| | 733.00 Osteoporosis, unspecified |
| | 733.01 Senile osteoporosis |
| | 733.02 Idiopathic osteoporosis |
| | 733.03 Disuse osteoporosis |
| | 733.09 Other) |
| | AND (Member's procedure history does NOT include |
| | any of the following CPT codes: |
| | 78350 - BONE MINERAL, SINGLE PHOTON |
| | 78351 - BONE MINERAL, DUAL PHOTON |
| | 76977 - US BONE DENSITY MEASURE |
| | 77078 - CT BONE DENSITY, AXIAL |
| | 77079 - CT BONE DENSITY, PERIPHERAL |
| | 77080 - DXA BONE DENSITY, AXIAL |
| | 77081 - DXA BONE DENSITY/PERIPHERAL |
| | 77082 - XA BONE DENSITY, VERT FX) |
| Recom- | Recommend follow-up with service provider regarding |
| mendation | osteoporosis screening. |
| | This consumer meets the criteria for regular |
| | osteoporosis screenings, but our records indicate that |
| | the consumer has not been screened for it in the past. |
| Hyperlink | View Guidelines |
| Text | (http://www.ahrq.gov/clinic/3rduspstf/osteoporosis/ |
| (URL) | osteorr.htm) |
| Citation | U.S. Preventive Services Task Force (2002) |
| Evidence | The U.S. Preventive Services Task Force (USPSTF) |
| | recommends that women aged 65 and older be screened |
| | routinely for osteoporosis. The USPSTF recommends that |
| | routine screening begin at age 60 for women at increased |
| | risk for osteoporotic fractures. |
| | Rating: B Recommendation. |

The content provider applies 56 the decision support rules to the received consumer profile information by applying a text recognition tool to the received consumer profile information to determine whether the received consumer profile information meets the criteria of the decision support rules. If the text recognition tool detects that the consumer profile information satisfies the criteria of one or more of the decision support rules, then the content provider generates and/or retrieves (e.g., from a database) the decision support information associated with the decision support rule for which the criteria has been met. The decision support information is associated with identifying information (e.g., name and address information, health identifier information, medical record identifier information) of the consumer, enabling the content provider and the brokerage system 10 to identify the consumer for which decision support information has been generated.

The content provider also sends 60 the decision support information to the brokerage system 10. The content provider generates a response message including the decision support information and sends 60 the response message to the brokerage system through the encrypted channels established with the brokerage system 10.

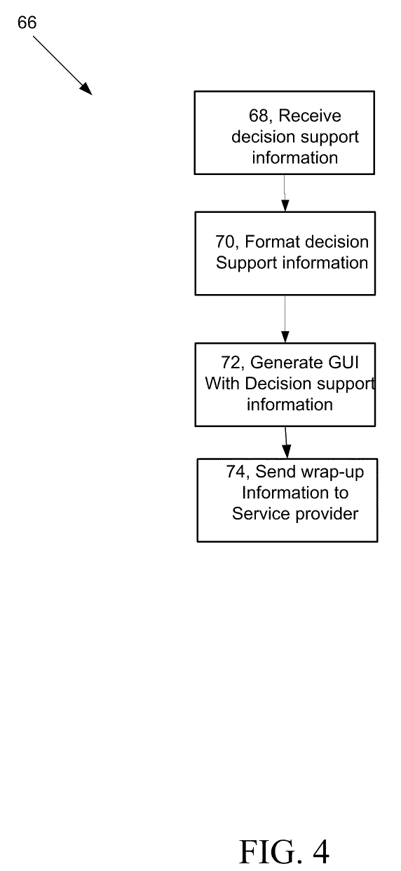

Referring to FIG. 4, the brokerage system 10 (and/or the decision support module 36) updates 66 a graphical user interface that renders a visual representation of decision support information as follows. The brokerage system 10 receives the response message including the decision support information from the content provider. The brokerage system 10 formats 70 the decision support information based on the data format specifications (e.g., XML and hyper-text markup language (“HTML”) specifications) of the brokerage system 10 to generate the decision support “items” that are integrated with the other health information stored by the database 34. The brokerage system 10 generates 72 a graphical user interface that when rendered on a display device 18, 20 (FIG. 1) renders a visual representation of the decision support items, for example, during a consultation with a consumer. When the service provider completes the consultation with the service provider, the brokerage system 10 generates another graphical user interface (e.g., with fields, text boxes, checkboxes, and buttons) through which the service provider enters post-consultation notes and information (e.g., wrap-up information). The brokerage system 10 sends 74 the post-consultation notes and information to the content provider 36, such that additional decision support information may be generated and presented to the service provider during the service provider's next consultation with the consumer.

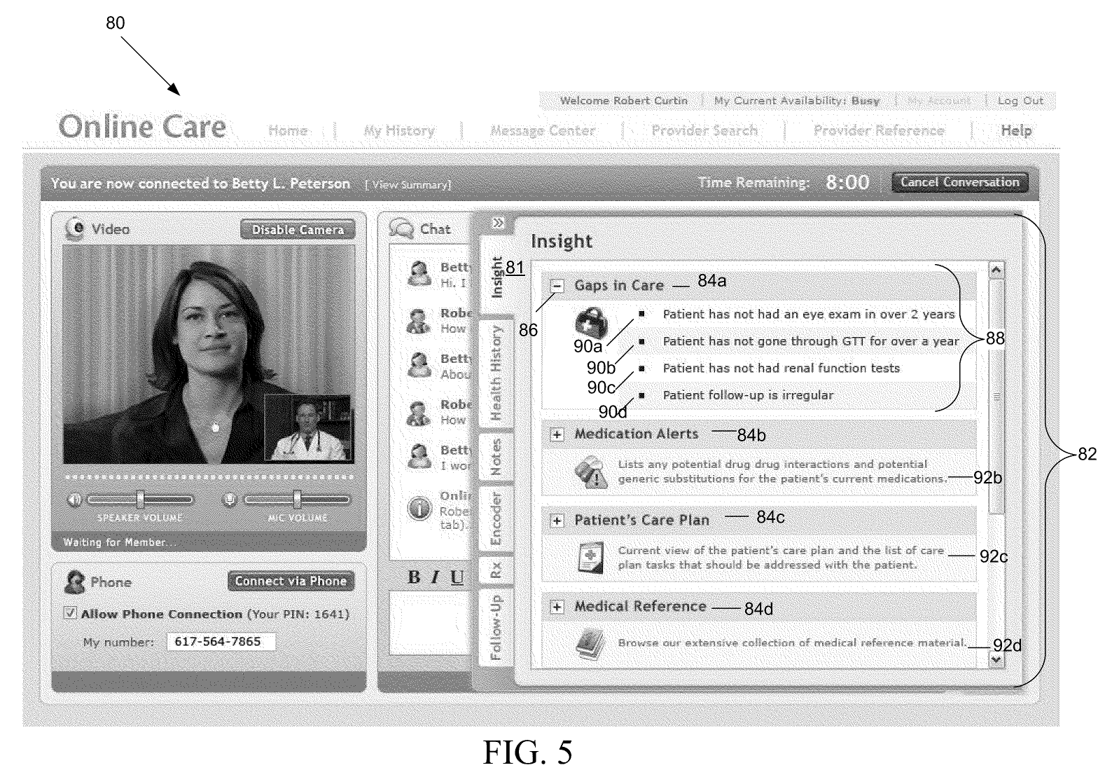

Referring to FIG. 5, the brokerage system 10 generates a graphical user interface 80 that when rendered on a display device 18, 20 (FIG. 1) (e.g., a display device used by the consumer or the service provider) renders a decision support tab 81, selection of which causes a visual representation 82 of the decision support items (e.g., during a real-time consultation between the service provider and the consumer) to be displayed on the display device 18, 20. A link (not shown) embedded in graphical user interface 80 enables service providers to quickly access the decision support tab 81, to encourage service providers to reference the decision support tab 81 throughout a consultation with a consumer and to assist the service provider in treating the consumer. The decision support items are presented and formatted according to content type (e., gaps in care information, medication alerts information, consumer's care plan information, medical reference information, and pay for performance information). Visual representation 82 includes decision support items 84a, 84b, 84c, 84d. The decision support items 84a, 84b, 84c, 84d are each associated with summary text 92b, 92c, 92d (92a not shown) explaining the types of information included in the decision support items 84a, 84b, 84c, 84d. Decision support item 84a is juxtaposed to control box 86 (or a link or other selectable area), selection of which causes decision support elements 90a, 90b, 90c, 90d associated with decision support item 84a to be displayed in an expanded or a collapsed view. In a visual representation 88 of the expanded view, the decision support elements 90a, 90b, 90c, 90d associated with decision support item 84a are displayed in the graphical user interface 80.

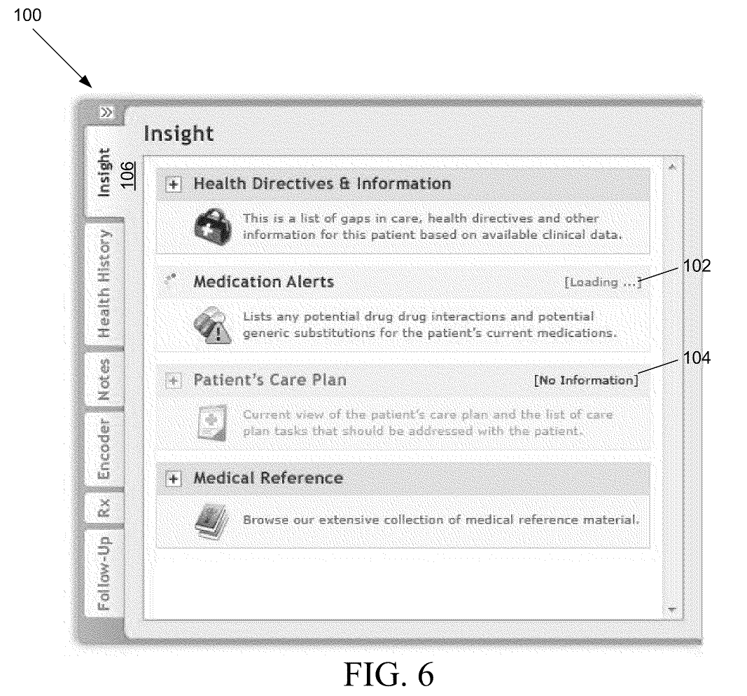

Referring to FIG. 6, the brokerage system 10 generates a graphical user interface 100 that when rendered on a display device 18, 20 renders visual representations 102, 104 indicative of the status of the decision support information being loaded into the decision support module 32. When a consumer or a service provider selects tab area 106, the brokerage system 10 loads the decision support information from the content providers 36 into the decision support module 32. The loading of the decision support information is initiated by the brokerage system 10 sending a request to the content providers 36 for updated decision support information. The loading of the decision support information is also initiated by the brokerage system 10 retrieving the updated decision support information from the database 34, for example, when the content provider is integrated with the brokerage system 10. Visual representation 102 indicates that decision support information associated with the “medication alerts” decision support item is being loaded from the content providers 36. Visual representation 104 indicates that no decision support information is associated with the “patient's care plan” decision support item.

The content providers 36 generate and retrieve the following type of decision support information: evidence-based clinical guidelines, medication interaction alerts, medication substitutions, physician-centric care management and coordination, pay for performance, program eligibility and medical reference.

Referring back to FIG. 5, the evidence-based clinical guidelines decision support item 84a identifies recommended service provider practices for a consumer, including gaps in care or health directives. For example, if a patient has not fulfilled the recommended lab tests for a person of a certain age, these tests are included in an evidence-based clinical guidelines decision support item.

The medication alerts decision support item 84b notifies service providers of potentially unsafe interactions between drugs that a consumer is taking, enabling the service provider to manage the consumer's medication usage and making the service provider aware of dangerous side effects.

The medication substitutions decision support item (not shown) includes a list of recommended alternative medications for prescribed medications. When a provider selects a medication (e.g., through a checkbox displayed in a graphical user interface) to prescribe to a consumer during a consultation with the consumer, the decision support module 32 generates a graphical user interface that when rendered on a display device 18, 20 (FIG. 1) displays generic versions or medically equivalent substitutions of the selected medication. The medication substitutions decision support item also includes cost savings information attributed to prescribing a generic versus a brand name medication.

The physician-centric care management and coordination decision support item 84c facilitates continuity of care across interactions with treating service providers. Providers reference the physician-centric care management and coordination decision support item 84c to help patients stay on track with care management recommendations and achieve health targets. For example, the physician-centric care management and coordination decision support item 84c includes a decision support element (not shown) to remind a diabetic patient to monitor his/her blood sugar regularly and update this information in the brokerage system 10.

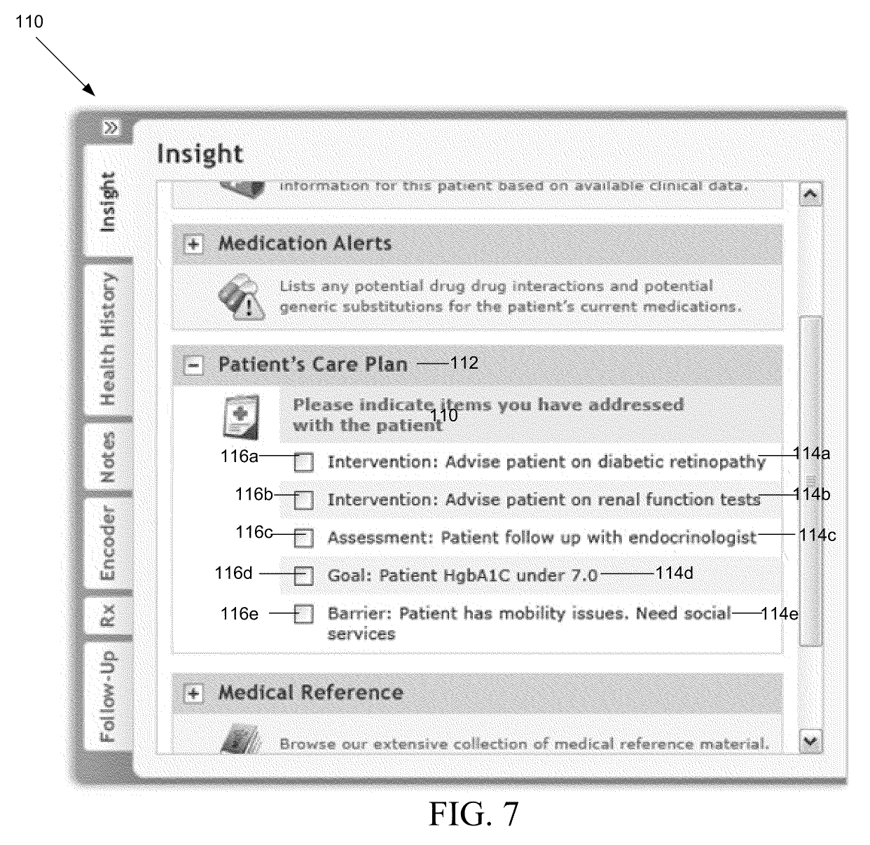

Referring to FIG. 7, the brokerage system 10 generates a graphical user interface 110 that when rendered on a display device 18, 20 (FIG. 1) renders a visual representation of the patient's care plan decision support item 112 and decision support elements 114a-114e, including text indicative of topics that the service provider had addressed with a consumer during a consultation. Each of the decision support elements 114a-114e is juxtaposed to a selectable field 116a-116e (e.g., a textbox, button, checkbox or other selectable field), selection of which indicates a topic that the service provider had addressed with the consumer. The decision support elements 114a-114e associated with the selected fields 116a-116e are stored in database 34 (e.g., to be accessed by other service providers to ensure continuity of care) and the consumer information is updated with the decision support elements 114a-114e associated with the selected fields 116a-116e. The brokerage system also generates and sends a message the content provider 36. The message includes data indicative of the decision support elements 114a-114e associated with the selected fields 116a-116e. The content provider 36 uses the decision support elements 114a-114e associated with the selected fields 116a-116e to update the consumer's profile information and generate additional decision support information.

The pay for performance decision support item (not shown) provides feedback to content providers 36. The feedback is used to pay the service providers for the consultations and services provided to the consumer. The decision support module 32 generates a graphical user interface that when rendered on a display device 18, 20 renders visual representations of discussion topics. A selectable field (e.g., a check box) is associated with each of the discussion topics. After a consultation with a consumer, the service provider selects the field associated with the discussion topics that were discussed with the consumer during the consultation. The decision support module 32 generates a message including information indicative of the selected discussion topics and sends the message to the content providers. A health plan (e.g., an insurance company) uses this information to determine an appropriate amount to compensate the service provider for the consultation, based in the topics that were discussed during the consultation.

The program eligibility decision support item (not shown) includes information specifying that a consumer is eligible for a program (e.g., a care management and/or a disease management program). The program eligibility decision support item facilitates enrollment in the program by notifying the provider of the consumer's eligibility and enabling the provider to address the consumer's eligibility with the consumer during the consultation so that the consumer may take appropriate follow-up action to complete registration in the program.

The medical reference decision support item 84d includes links to information repositories and sources (e.g., Medline Plus, Healthwise, and UpToDate, Inc) that provide service providers with reference health information (e.g., during a consultation with a consumer).

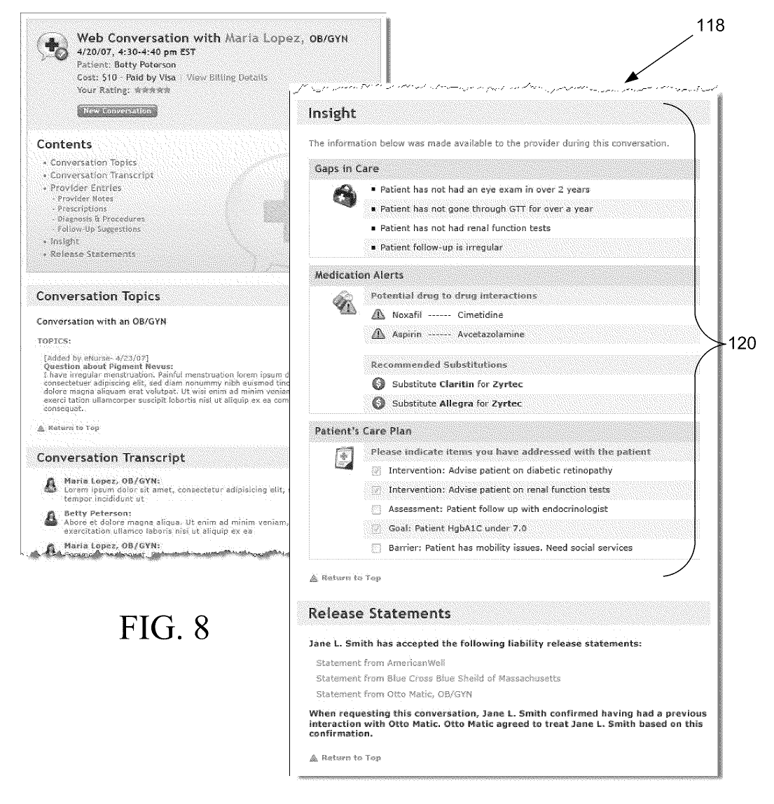

Referring to FIG. 8, the brokerage system 10 generates a consultation report 118 including a visual representation 120 of the decision support items (generated by the decision support module 36) to ensure that the consumer, the service provider, and other service providers are kept informed of the recommendations made during the consultation. The consultation report with the integrated decision support information allows consumers to reference recommendations made by a service provider within the context of the communication, encouraging the consumer to follow-up on issues discussed with the service provider. Through the consultation report 118, the consumer and the provider are able to review the information that was discussed during the communication without manually recording the discussed information. The consultation report also ensures that the clinical value of the recommendations and the decision support information is maintained in one record. The consultation report is accessible to the consumer and the service provider through a graphical user interface generated by the brokerage system 10 and is also forwarded, by the brokerage system 10, to the consumer's primary care physician or other service provider.

Embodiments can be implemented in digital electronic circuitry, or in computer hardware, firmware, software, or in combinations thereof. An apparatus can be implemented in a computer program product tangibly embodied or stored in a machine-readable storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be information in different formats such as text, graphics, images, sound, video, Hypertext Markup Language (HTML), as well as programs. Upon specification of a link by the user, the client computer makes a TCP/IP request to a Web server and receives information, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Sun, Linux, and Macintosh may also be used. Computer users can view information available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Additionally, due to the nature of software, functions described above can be implemented using software, hardware, firmware, hardwiring, or combinations of any of these. Features implementing functions may also be physically located at various positions, including being distributed such that portions of functions are implemented at different physical locations.

A number of exemplary embodiments of the invention have been described. Nevertheless, it will be understood by one of ordinary skill in the art that various modifications may be made without departing from the spirit and scope of the invention. For example, the processes described herein that are implemented by the brokerage system 10 may also be specifically implemented by the decision support module 32 within the brokerage system 10. Accordingly, other embodiments are within the scope of the following claims.

What is claimed is:

1. A computer-implemented method comprises:
retrieving, from a data repository that stores decision support information, decision support information pertinent to a consumer of services with whom a service provider is engaged in a real-time consultation; and
generating by one or more computers based on the retrieved decision support information one or more decision support items to facilitate decisions of the service provider in rendering medical care to the consumer of services.

2. The computer-implemented method of claim 1 wherein the decision support items comprise one or more visual representations of data to facilitate decisions of the service provider in rendering medical care to the consumer of services and include one or more of a first item that identifies omissions in health care coverage of the consumer of services, a second item that identifies medication alerts for medications that were prescribed to the consumer of services, and a third item that identifies a list of generic substitutions for the consumer's present medications.

3. The computer-implemented method of claim 1 wherein the data repository is a first data repository and wherein the method further comprises:
retrieving from a second data repository health information pertinent to the consumer of services; and
causing the one or more computers to apply one or more decision support rules to the retrieved health information to generate the decision support information.

4. The computer-implemented method of claim 1 further comprising:
sending by the one or more computers to the service provider a message, the message including the one or more decision support items.

5. The computer-implemented method of claim 1 further comprising:
generating a graphical user interface that when rendered on a display device displays a visual representation of the one or more decision support items.

6. The computer-implemented method of claim 1 further comprising:
sending to the data repository that stores decision support information data indicative of one or more decision support items addressed with the consumer during the consultation.

7. The computer-implemented method of claim 1 wherein the data repository is a first data repository and wherein the method further comprises:
retrieving from a second data repository health information pertinent to the consumer of services; and
causing the one or more computers to send to the first data repository the retrieved health information pertinent to the consumer of services.

8. A computer program product embodied on a computer readable storage medium, the computer program product comprising instructions for causing a computer to:
retrieve, from a data repository that stores decision support information, decision support information pertinent to a consumer of services with whom a service provider is engaged in a real-time consultation; and
generate based on the retrieved decision support information one or more decision support items to facilitate decisions of the service provider in rendering medical care to the consumer of services.

9. The computer program product of claim 8 wherein the decision support items comprise one or more visual representations of data to facilitate decisions of the service provider in rendering medical care to the consumer of services and include one or more of a first item that identifies omissions in health care coverage of the consumer of services, a second item that identifies medication alerts for medications that were prescribed to the consumer of services, and a third item that identifies a list of generic substitutions for the consumer's present medications.

10. The computer program product of claim 8 wherein the data repository is a first data repository and wherein the computer program product further comprises instructions for causing the computer to:
retrieve from a second data repository health information pertinent to the consumer of services; and
apply one or more decision support rules to the retrieved health information to generate the decision support information.

11. The computer program product of claim 8 wherein the computer program product further comprises instructions for causing the computer to:
send to the service provider a message, the message including the one or more decision support items.

12. The computer program product of claim 8 wherein the computer program product further comprises instructions for causing the computer to:
generate a graphical user interface that when rendered on a display device displays a visual representation of the one or more decision support items.

13. The computer program product of claim 8 wherein the computer program product further comprises instructions for causing the computer to:
send to the data repository that stores decision support information data indicative of one or more decision support items addressed with the consumer during the consultation.

14. The computer program product of claim 8 wherein the data repository is a first data repository and wherein the computer program product further comprises instructions for causing the computer to:
retrieve from a second data repository health information pertinent to the consumer of services; and
send to the first data repository the retrieved health information pertinent to the consumer of services.

15. An apparatus comprising:
a processor; and
a computer program product embodied on a computer readable storage medium, the computer program product comprising instructions for causing the processor to:
retrieve, from a data repository that stores decision support information, decision support information pertinent to a consumer of services with whom a service provider is engaged in a real-time consultation; and
generate based on the retrieved decision support information one or more decision support items to facilitate decisions of the service provider in rendering medical care to the consumer of services.

16. The apparatus of claim 15 wherein the decision support items comprise one or more visual representations of data to facilitate decisions of the service provider in rendering medical care to the consumer of services and include one or more of a first item that identifies omissions in health care coverage of the consumer of services, a second item that identifies medication alerts for medications that were prescribed to the consumer of services, and a third item that identifies a list of generic substitutions for the consumer's present medications.

17. The apparatus of claim 15 wherein the data repository is a first data repository and wherein the computer program product further comprises instructions for causing the computer to:
retrieve from a second data repository health information pertinent to the consumer of services; and
apply one or more decision support rules to the retrieved health information to generate the decision support information.

18. The apparatus of claim 15 wherein the computer program product further comprises instructions for causing the computer to:
send to the service provider a message, the message including the one or more decision support items.

19. The apparatus of claim 15 wherein the computer program product further comprises instructions for causing the computer to:
generate a graphical user interface that when rendered on a display device displays a visual representation of the one or more decision support items.

20. The apparatus of claim 15 wherein the computer program product further comprises instructions for causing the computer to:
send to the data repository that stores decision support information data indicative of one or more decision support items addressed with the consumer during the consultation.

21. The apparatus of claim 15 wherein the data repository is a first data repository and wherein the computer program product further comprises instructions for causing the computer to:
retrieve from a second data repository health information pertinent to the consumer of services; and
send to the first data repository the retrieved health information pertinent to the consumer of services.
